(19) United States
(12) Patent Application Publication
(10) Pub. No.: US 2020/0056776 A1
(43) Pub. Date: Feb. 20, 2020

(54) Sneaky Hunters Boot Lamp

(71) Applicant: James Manroe, Salmon, ID (US)

(72) Inventor: James Manroe, Salmon, ID (US)

(21) Appl. No.: 16/395,182

(22) Filed: Apr. 25, 2019

Related U.S. Application Data
(60) Provisional application No. 62/663,222, filed on Apr. 26, 2018.

(51) Int. Cl. F21V 33/00; F21V 15/01; F21V 23/02; F21V 23/04; F21V 21/08; F21V 3/02; A43B 3/00

(52) U.S. Cl. CPC F21V 33/0008; F21V 15/01; F21V 23/02; F21V 23/0414; F21W 2131/30; F21V 21/0816; F21V 3/02; A43B 3/001; F21V 21/0832

(57) ABSTRACT

A boot lamp includes a housing, the housing secures one or more batteries, one or more light sources, one or more electric contacts, one or more straps, and one or more attachment prongs to a boot; and wherein the one or more attachment prongs engage the boot forming a first attachment point to the boot and the one or more straps engage the boot forming a second attachment point to the boot. The boot lamp described herein may be used in climbing, caving, biking, hunting, hiking, or mountaineering.

### RELATED APPLICATIONS

This application claim priority to previously filed U.S. provisional application 62/663,222 titled “Sneaky Hunters Boot Lamp” filed on Apr. 26, 2018 which is hereby incorporated by reference.

### FIELD OF THE INVENTION

The present invention relates generally to lighting and more specifically to shoe or boot lighting devices.

### SUMMARY

A boot lamp includes: a housing, the housing securing one or more batteries, one or more light sources, one or more electric contacts, one or more straps, and one or more attachment prongs to a boot; and wherein the one or more attachment prongs engage the boot forming a first attachment point to the boot and the one or more straps engage the boot forming a second attachment point to the boot. The boot lamp described herein may be used in climbing, caving, biking, hunting, hiking, or mountaineering. A “boot” as used herein is defined as any covering for a foot of a person such as a hunting boot, running shoe, tennis shoe, hiking boot, sock, biking shoe, basketball shoe, climbing shoe, etc.

The boot lamp may include one or more attachment prongs protruding in a similar direction as an illumination path of the one or more light sources. The boot lamp may include one or more straps that are at least partially elastic. The boot lamp may include at least one red light source. The boot lamp may include least one violet light source. The boot lamp may include at least one green light source. The boot lamp may include one or more electric contacts that are actuated by a foot button or switch located on an exterior surface of the housing. The boot lamp may include one or more white light sources. The boot lamp may include at least one LED (light emitting diode) light source. The boot lamp may include at least one light source emitting a peak wavelength between 420 nm and 480 nm. The boot lamp may include at least one light source not visible to elk or deer. The boot lamp may include a latch and hook strap. The boot lamp may include a pull-type strap. The boot lamp may include a buckle strap. The boot lamp may include one or more straps that provide stability to the boot lamp in a first direction and one or more prongs that provide stability to the boot lamp in a second direction. The boot lamp may provide one or more light sources that are repositionable to change an illumination path created by the one or more light sources. The boot lamp may provide at least one red light source. The boot lamp may further comprise a light cover for changing optical properties of the light produced by the one or more light sources. The boot lamp light cover may aid in the illumination of blood. The boot lamp lens cover may collimate or focus the light produced by the one or more light sources.

A sneaky hunters boot lamp is unique in design as it is made for sneaking into hunting areas in the dark with very little disturbance. The boot lamp is made with an “ON” and “OFF” switch that can be easily operated with a foot of a user. The switch may be a push button style with different stages. The switch and boot lamp may be water resistant. The lamp may have three or more stages or positions including: white LED light, green LED light, red LED light, blue LED light, and an off position. The light may also fasten to the laces on a hunting boot or other protective foot product. The lamp may also include a strap or belt to secure the lamp to an arch of a boot, the strap or belt may tighten and secure the lamp to a boot or shoe. The lamp may be battery powered with 3 Triple AAA batteries that can be changed in the field if necessary.

The sneaky hunters boot lamp is designed to give big game hunters an advantage getting into remote areas during dark or low lighting hours. The light from the boot lamps will stay low to the ground while trying to reach areas where big game retreat to or live (the Zone). When reaching close to the zone hunters can use the boot lamps in a red-light mode. Many big game animals such as deer and elk don't see red light or the color red at all. This gives the hunter an advantage he never had before when they enter the zone. Hunting success rates are better when one or more hours are spent on the trail before daylight. The boot lamp disclosed herein may be especially useful in tracking and hunting a wide variety of animals including those with limited eye sight in color spectra which is visible to humans and invisible to the animal.

Hikers and cavern may also use the boot lamp device for hiking in dark conditions such as in early morning hours, evening hours, night hours, and climbing or hiking in dimly lit or dark areas. Bicycle riders may also use the boot lamps for illuminating a forward bike path and for rider detection by motor vehicle operators when riding in dimly lit conditions. The boot lamp described herein may be used in climbing, caving, biking, hunting, hiking, or mountaineering.

An angle of the boot lamp may be adjusted, so the light shining over the toe area of the boot floods over the ground in front of the boot. The number of light bulbs may be one or more. Light brightness may be determined by selection of lights and quantity of lights. A royal blue lens may be added and used to track blood of a wounded animal in the dark.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows two boot lamps in accordance with an embodiment of the invention;

FIG. 2 depicts actuation of a boot lamp in accordance with an embodiment of the invention;

FIG. 3 shows a perspective view of a boot lamp device in accordance with an embodiment of the invention;

FIG. 4 shows a front perspective view of a boot lamp device in accordance with an embodiment of the invention;

FIG. 5 shows a rear perspective view of a boot lamp device in accordance with an embodiment of the invention;

FIG. 6 shows a top perspective view of a boot lamp device in accordance with an embodiment of the invention;

FIGS. 7A-7D show aspects of boot lamp device in accordance with an embodiment of the invention; and

FIG. 8 shows a removable cover lens of a boot lamp device in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention but is merely representative of certain examples of presently contemplated embodiments in accordance with the invention. The presently described embodiments will be best understood by reference to the drawings.

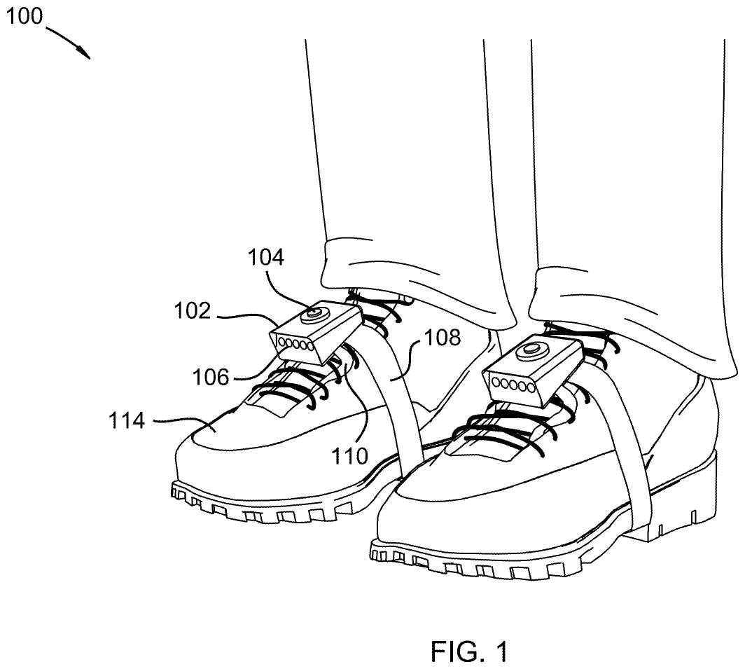

FIG. 1 shows two boot lamp devices attached to left and right feet of a user 100. Boot lamp 102 includes a multiple selection button 104, one or more LED lights 106, an arch strap 108, and one or more shoe lace clips 110. In one embodiment, lace clip(s) 110 extend in a generally parallel direction to an illumination path of LED lights 106 while strap 108 extends in a generally perpendicular direction to an illumination path of LED lights 106 and clip(s) 110.

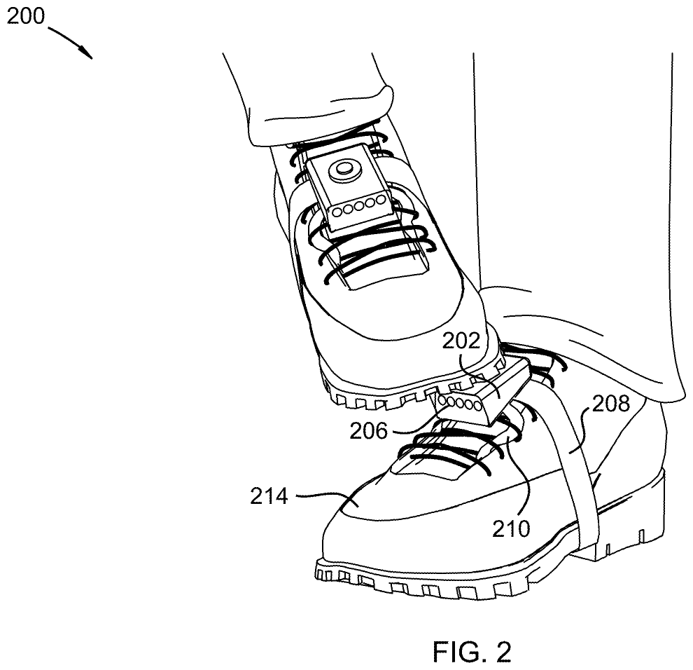

FIG. 2 shows actuation of boot lamp 202 by a foot of user 200. In one embodiment, when a top button on boot lamp 202 is depressed a first-time white light illuminates from one or more LEDs 206 of boot lamp 202, when the top button is depressed a second-time red light illuminates from one or more LEDs of boot lamp 202, and when the top button is pressed a third-time the boot lamp shuts off. In other embodiments, additional colors such as blue and/or green may illuminate when top button is depressed. The top button may have 2-6 selectable positions for illuminating different colors and turning “ON” or “OFF” the boot lamp.

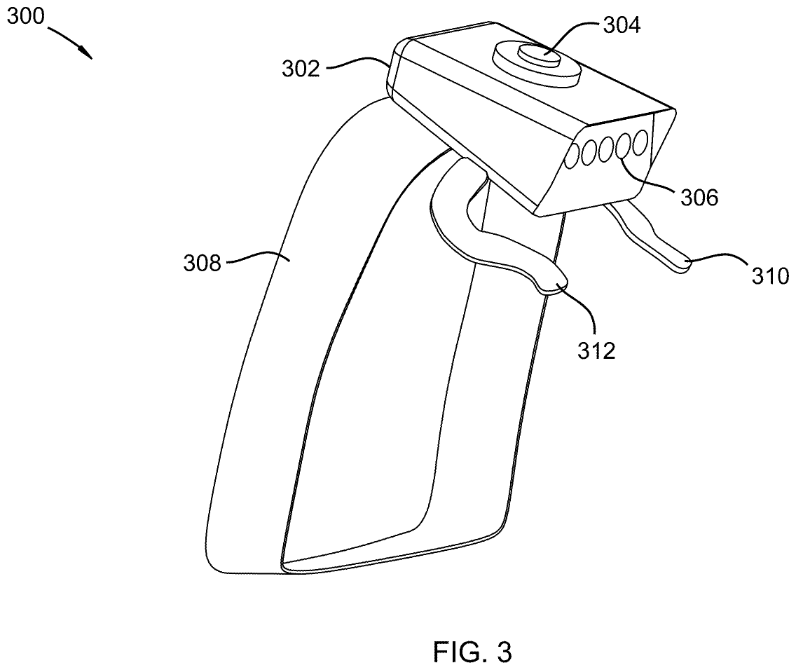

FIG. 3 shows a boot lamp device 300 in according to an embodiment of the invention. Boot lamp 300 includes a main body portion 302, multiple selection button 304, one or more LED lights 306, an arch strap 308, and one or more shoe lace clips (protruding attachment prongs) 310/312. In one embodiment, lace clip(s) 310/312 extend in a generally parallel direction to an illumination path of LED lights 306 while strap 308 extends in a generally perpendicular direction to an illumination path of LED lights 306 and clip(s) 310/312. Main body portion 302 may be made of rugged plastic, metal, fiberglass, or a combination thereof. Protruding attachment prongs 310/312 may engage a lace of a boot, a lace hole of a boot, or a lace flap of a boot or shoe.

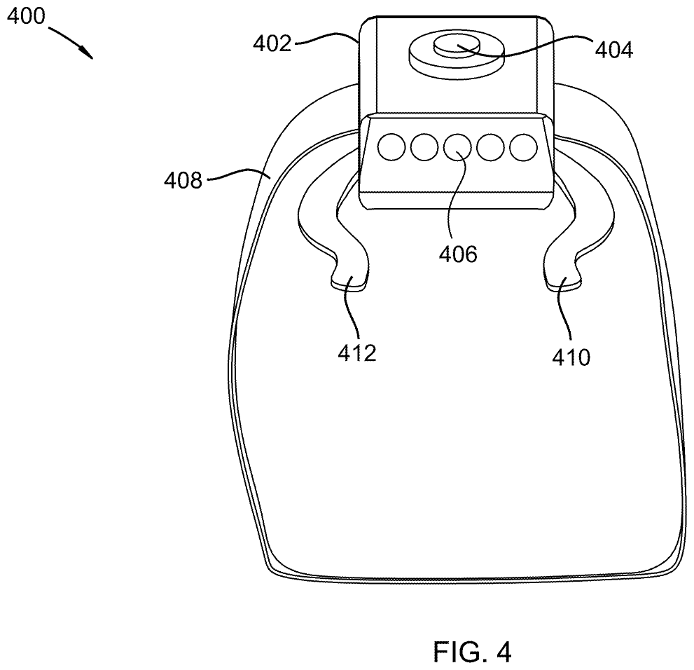

FIG. 4 shows a boot lamp device 400 in according to an embodiment of the invention. Boot lamp 400 includes a main body portion 402, multiple selection button 404, one or more LED lights 406, an arch strap 408, and one or more shoe lace protruding attachment prongs 410/412. In one embodiment, protruding attachment prongs 410/412 extend in a generally parallel direction to an illumination path of LED lights 406 while strap 408 extends in a generally perpendicular direction to an illumination path of LED lights 406 and clip(s) 410/412. Main body portion 402, prongs 410/412, and strap 408 may be made of rugged plastic, metal, nylon, leather, fiberglass, elastic, or a combination thereof.

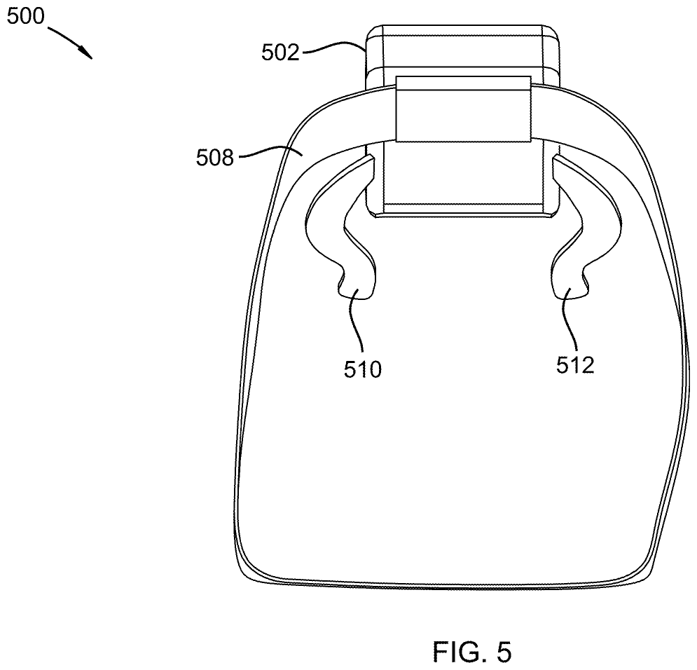

FIG. 5 shows a boot lamp device 500 in according to an embodiment of the invention. Boot lamp 500 includes a main body portion 502, an arch strap 508, and one or more shoe lace clips 510/512. In one embodiment, protruding attachment prongs 510/512 extend in a generally parallel direction to an illumination path of LED lights (not shown) while strap 508 extends in a generally perpendicular direction to an illumination path of LED lights (not shown) and clip(s) 510/512. Main body portion 502, clips 510/512, and strap 508 may be made of rugged plastic, metal, nylon, leather, fiberglass, or a combination thereof.

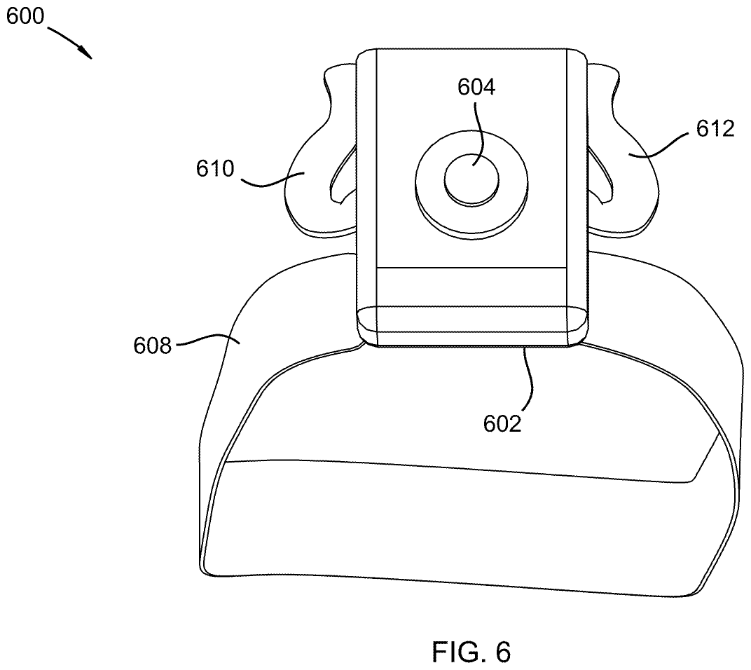

FIG. 6 shows a boot lamp device 600 in according to an embodiment of the invention. Boot lamp 600 includes a rear main body portion 602, an arch strap 608, and one or more shoe lace clips 610/612. In one embodiment, protruding attachment prongs 610/612 extend in a generally parallel direction to an illumination path of LED lights (not shown) while strap 608 extends in a generally perpendicular direction to an illumination path of LED lights (not shown) and clip(s) 610/612. Main body portion 602, protruding attachment prongs 610/612, and strap 608 may be made of rugged plastic, metal, nylon, leather, fiberglass, elastic, or a combination thereof.

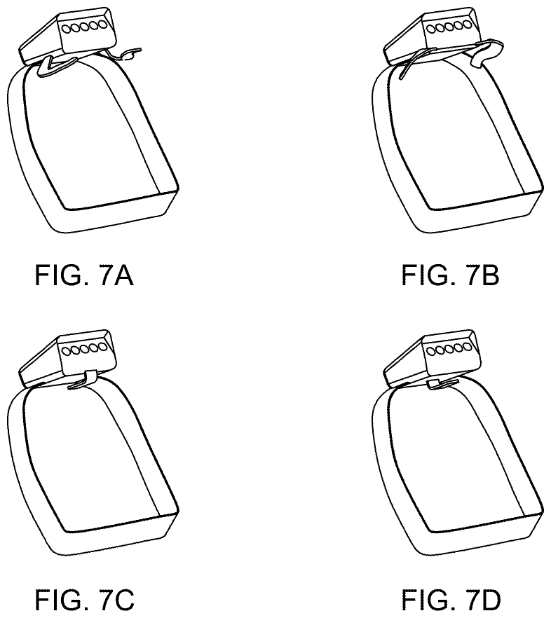

FIGS. 7A-7D show various embodiments of boot lamps with one or more protruding attachment prongs extending in a generally parallel direction compared to a light path of the LED lights.

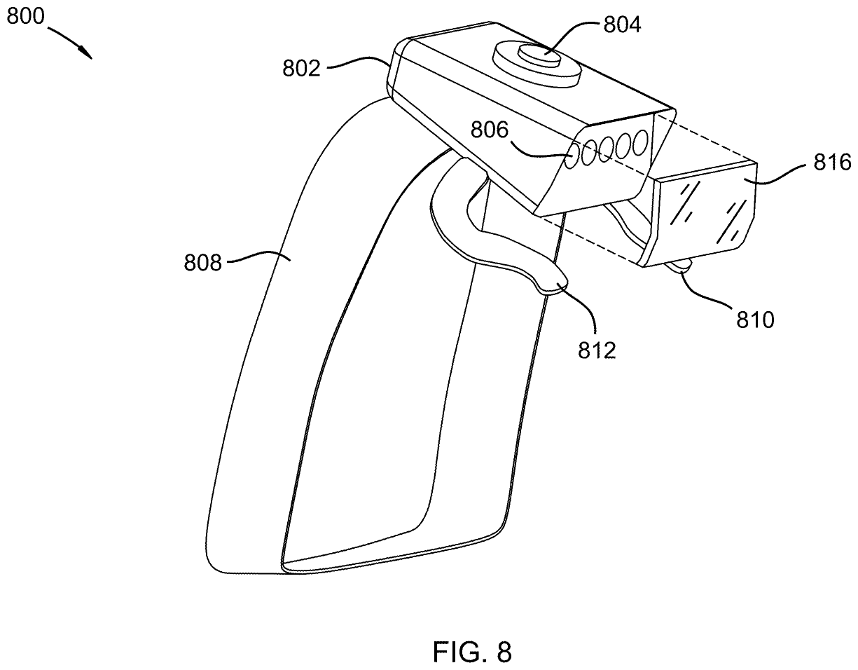

FIG. 8 shows a boot lamp device 800 in according to an embodiment of the invention. Boot lamp 800 includes a main body portion 802, multiple selection button 804, one or more LED lights 806, an arch strap 808, a lens cover 816, and one or more shoe lace clips 810/812. In one embodiment, lace clip(s) 810/812 extend in a generally parallel direction to an illumination path of LED lights 806 while strap 808 extends in a generally perpendicular direction to an illumination path of LED lights 806 and protruding attachment prongs 810/812. Main body portion 802 may be made of rugged plastic, metal, fiberglass, or a combination thereof. Lens cover 816 may be configured to block certain wavelengths of light allowing for tracking and illumination of blood from wounded animals. In one embodiment, lens cover 816 allows blue light to be transmitted though lens cover 816 for the tracking of animal blood.

The systems and methods disclosed herein may be embodied in other specific forms without departing from their spirit or essential characteristics. The described embodiments are to be considered in all respects only as illustrative and not restrictive. All changes which come within the meaning and range of equivalency of the claims are to be embraced within their scope.

1. A boot lamp comprising:
a housing, the housing securing one or more batteries, one or more light sources, one or more electric contacts, one or more straps, and one or more attachment prongs to a boot; and
wherein the one or more attachment prongs engage the boot for a first attachment point to the boot and the one or more straps engage the boot forming a second attachment point to the boot.

2. The boot lamp of claim 1, wherein the one or more attachment prongs protrude in a similar direction as an illumination path of the one or more light sources.

3. The boot lamp of claim 1, wherein the one or more straps are at least partially elastic.

4. The boot lamp of claim 1, wherein the one or more light sources includes at least one red light source.

5. The boot lamp of claim 1, wherein the one or more light sources includes at least one violet light source.

6. The boot lamp of claim 1, wherein the one or more light sources includes at least one green light source.

7. The boot lamp of claim 1, wherein the one or more electric contacts are actuated by a foot button or switch located on an exterior surface of the housing.

8. The boot lamp of claim 1, wherein the one or more light sources includes at least one white light source.

9. The boot lamp of claim 1, wherein the one or more light sources includes at least one LED (light emitting diode) light source.

10. The boot lamp of claim 1, wherein the one or more light sources includes at least one light source emitting a peak wavelength between 420 nm and 480 nm.

11. The boot lamp of claim 1, wherein the one or more light sources includes at least one light source not visible to elk or deer.

12. The boot lamp of claim 1, wherein the one or more straps includes a hook and loop strap.

13. The boot lamp of claim 1, wherein the one or more straps include a pull-type strap.

14. The boot lamp of claim 1, wherein the one or more straps include a buckle strap.

15. The boot lamp of claim 1, wherein the one or more straps provide stability to the boot lamp in a first direction and the one or more prongs provide stability to the boot lamp in a second direction.

16. The boot lamp of claim 1, wherein the one or more light sources are repositionable to change an illumination path created by the one or more light sources.

17. The boot lamp of claim 1, wherein the one or more light sources includes at least one blue light source.

18. The boot lamp of claim 1, further comprising a light cover for changing optical properties of the light produced by the one or more light sources.

19. The boot lamp of claim 1, wherein the boot lamp is used in climbing, caving, biking, hunting, hiking, or mountaineering.

20. The boot lamp of claim 18, wherein the light cover collimates or focuses the light produced by the one or more light sources.
